(19) United States
(12) Patent Application Publication
(10) Pub. No.: US 2010/0134360 A1
(43) Pub. Date: Jun. 3, 2010

(54) INTEGRATED ANTENNA OF PARALLEL-RING TYPE

(76) Inventors: Byung Hoon Ryou, Seoul (KR); Won Mo Sung, Gyeonggi-do (KR); Jae Young Lee, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/522,913

(22) PCT Filed: Jan. 10, 2008
(86) PCT No.: PCT/KR2008/000164

§ 371 Date: Jan. 12, 2010

(30) Foreign Application Priority Data
Jan. 11, 2007 (KR) 10-2007-0003272

(51) Int. Cl. H01Q 1/38; H01Q 1/24

(52) U.S. Cl. 343/702; 343/700 MS

(57) ABSTRACT

The present invention relates to a parallel-ring integrated antenna. The integrated antenna in accordance with the present invention includes a parallel ring including a plurality of rings and a central conductor, and a high dielectric body coupled to the parallel ring. Return loss can be changed depending on a thickness of the ring, a first diameter, i.e., a diameter of the ring, a distance between the rings or a second diameter, i.e., a diameter of a central conductor. Further, the high dielectric body has a groove formed therein to correspond to an external shape of the parallel ring. The parallel ring is coupled to the high dielectric body through the groove. Thus, the integrated antenna of the present invention can obtain a maximum gain and active performance while maintaining the size of an existing chip antenna and can have its size and structure changed easily and conveniently by combining the high dielectric body with the parallel ring.

### TECHNICAL FIELD

The present invention relates to a parallel-ring type integrated antenna, and more particularly, to an integrated antenna, which can enhance the gain and active performance to the maximum while maintaining the size of an existing chip antenna and can be implemented without any carrier, thus saving the manufacturing cost.

### BACKGROUND ART

In the past, an external antenna was generally used in mobile communication devices. The external antenna literally refers to an antenna protruding externally and is a helical type antenna in which coils are wound on the antenna in a spiral shape. Although the external antenna is still used due to its good performance, there is a tendency that the external antenna gradually changes to an integrated antenna because of design orientation and miniaturization of mobile communication devices.

However, the integrated antenna is disadvantageous in that it is poor in terms of space utilization due to its bulky size and must be designed again when a new mobile communication device comes out due to its non-standard. A ceramic chip antenna starts to appear due to the disadvantages of the integrated antenna.

This ceramic chip antenna can be largely classified into a bulk type and a LTCC (Low Temperature Co-fired Ceramic) type. The bulk type ceramic chip antenna adopts a method of implementing radiators by coating a pattern on a ceramic surface, and the LTCC type ceramic chip antenna adopts a method of laminating a pattern within a ceramic in order to improve performance.

The term “LTCC” refers to a ceramic material or technology in which a plurality of passive elements can be implemented in one chip form by implementing a plurality of passive elements L, R and C and an interconnection circuit over a non-cofired dielectric ceramic called a green sheet using an electrode circuit made of silver (Ag), copper (Cu) etc. with an excellent electrical conductivity, laminating them in a three-dimensional manner, and co-firing the electrode and the ceramic at a 900 degrees Celsius, which is below the melting point of the circuit electrode.

This chip antenna has generally been used for a single frequency or a sub-band such as Bluetooth, wireless LAN and GPS (Global Positioning System), but is problematic in that it is difficult to secure a low frequency bandwidth in view of the dielectric constant and material property in the ceramic itself.

Further, as radio communication related technologies such as Bluetooth, wireless LAN, WiBro and Zigbee in addition to mobile communication are rapidly spread, miniaturization and embedment for mounting the technologies are in progress rapidly. Thus, there is an urgent need for an integrated antenna which can increase the floor area ratio within the circuit and the gain.

### DISCLOSURE

### [Technical Problem]

Accordingly, the present invention has been made in view of the above problems occurring in the prior art, and the present invention presents a new technology regarding a parallel-ring integrated antenna.

An object of the present invention is to design an integrated antenna, which can obtain a maximum gain and active performance while maintaining the size of an existing chip antenna and can perform a change in the size and structure easily and conveniently in designing the antenna by combining a high dielectric body with the parallel ring.

Another object of the present invention is to design an integrated antenna, which can easily secure the bandwidth, facilitate a change of the frequency and can be tuned easily, by employing a change in return loss depending on a change in a ring thickness of a parallel ring, a distance between the rings, the diameter of the ring or the diameter of a central conductor.

Still another object of the present invention is to design an integrated antenna which can save the manufacturing cost through a structure that can be implemented without any carrier.

### [Technical Solution]

To achieve the above objects and solve the conventional problems, an integrated antenna in accordance with an embodiment of the present invention includes a parallel ring including a plurality of rings and a central conductor, and a high dielectric body coupled to the parallel ring.

In accordance with an aspect of the present invention, return loss may be changed depending on a thickness of the ring, a first diameter, i.e., a diameter of the ring, a distance between the rings or a second diameter, i.e., a diameter of a central conductor.

In accordance with another aspect of the present invention, the high dielectric body may have a groove formed thereinto correspond to an external shape of the parallel ring. The parallel ring may be coupled to the high dielectric body through the groove.

In accordance with still another aspect of the present invention, the parallel ring may further include two contact structures connected to a Printed circuit board (PCB). The two contact structures may become a feed line and a ground GND, respectively.

### [Advantageous Effects]

In accordance with the present invention, an integrated antenna can be designed which can obtain a maximum gain and active performance while maintaining the size of an existing chip antenna and can change in the size and structure easily and conveniently in designing the antenna by combining a high dielectric body with the parallel ring.

In accordance with the present invention, an integrated antenna can be designed which can easily secure the bandwidth, have its frequency changed easily and can be tuned easily by employing a change in return loss depending on a change in a ring thickness of a parallel ring, a distance between the rings, the diameter of the ring or the diameter of a central conductor.

In accordance with the present invention, an integrated antenna can be designed which can save the manufacturing cost through a structure that can be implemented without any carrier.

### DESCRIPTION OF DRAWINGS

Further objects and advantages of the invention can be more fully understood from the following detailed description taken in conjunction with the accompanying drawings in which:

FIG. 1 is a view illustrating a parallel-ring type integrated antenna in accordance with an embodiment of the present invention;

FIG. 2 is a view illustrating a parallel ring in accordance with an embodiment of the present invention;

FIG. 3 shows an example of a change in return loss depending on a change in the thickness of the ring;

FIG. 4 shows an example of a change in return loss depending on a change in the distance between the rings;

FIG. 5 shows an example of a change in return loss depending on a change in the diameter of a central conductor;

FIG. 6 shows an example of a change in return loss depending on a change in the diameter of the ring;

FIG. 7 shows an example of a change in return loss depending on a change in the entire length of the parallel ring;

FIG. 8 is a view illustrating a high dielectric constant in accordance with an embodiment of the present invention; and

FIG. 9 is a view illustrating contact structures in accordance with an embodiment of the present invention.

### BEST MODE

The present invention will now be described in detail in connection with various embodiments with reference to the accompanying drawings. In this specification, it is interpreted that the term “radio transceiver” generally refers to apparatuses for transmitting or receiving electric waves wirelessly.

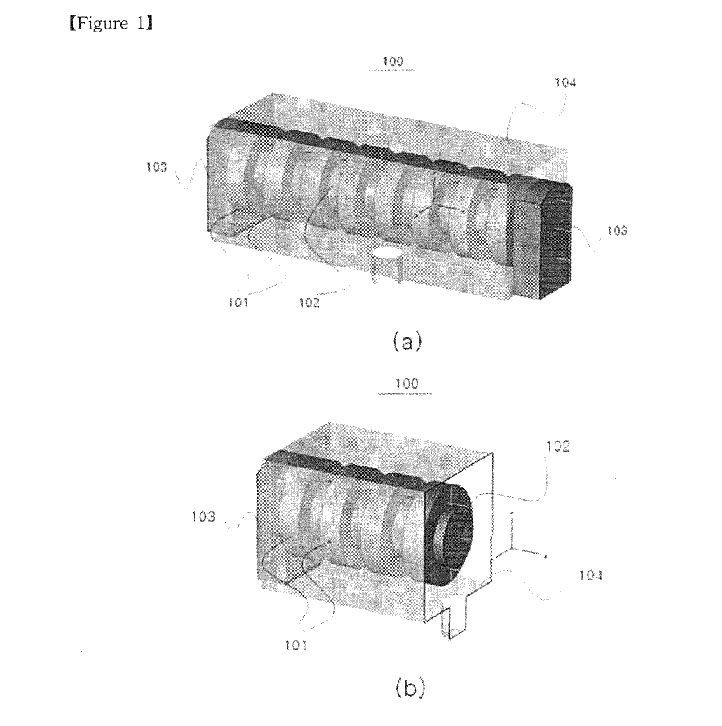

FIG. 1 is a view illustrating a parallel-ring type integrated antenna in accordance with an embodiment of the present invention. Here, reference numeral “a” of FIG. 1 designates an integrated antenna 100 in accordance with the present invention and reference numeral “b” indicates a sectional view of the integrated antenna 100.

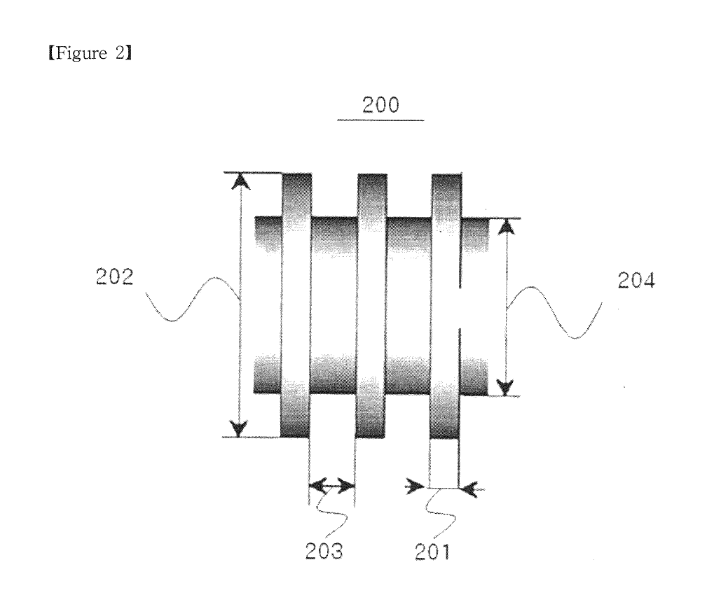

The integrated antenna 100 may include, as shown in FIG. 1, a parallel ring comprising a plurality of rings 101, a central conductor 102 and two contact structures 103 mounted on a Printed circuit board (PCB), and a high dielectric body 104 externally coupled to the parallel ring. The parallel ring is first described with reference to FIGS. 2 to 7.

FIG. 2 is a view illustrating a parallel ring in accordance with an embodiment of the present invention.

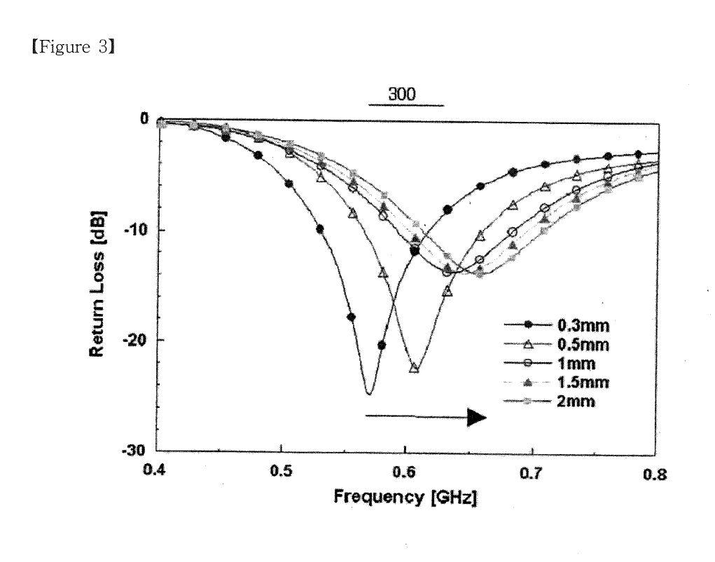

A parallel ring 200 may have its return loss changed depending on a thickness 201 of the ring 101, a diameter 202 of the ring 101, a distance 203 between the rings 101 or a diameter 204 of a central conductor 102. Such a change in return loss is described in more detail with reference to FIGS. 3 to 7.

FIG. 3 shows an example of a change in return loss depending on a change in the thickness of the ring. As shown in FIG. 3, a graph 300 illustrates return loss depending on the frequency when the thickness 201 of the ring 101 is 0.3 mm, 0.5 mm, 1 mm, 1.5 mm and 2 mm.

From the graph 300, it can be seen that as the thickness 201 increases from 0.3 mm to 2 mm, a resonant point shifts to a high frequency. This is because the electrical length of the antenna is shortened as the thickness 201 of the ring 101 increases under conditions in which the length of a loading portion is fixed.

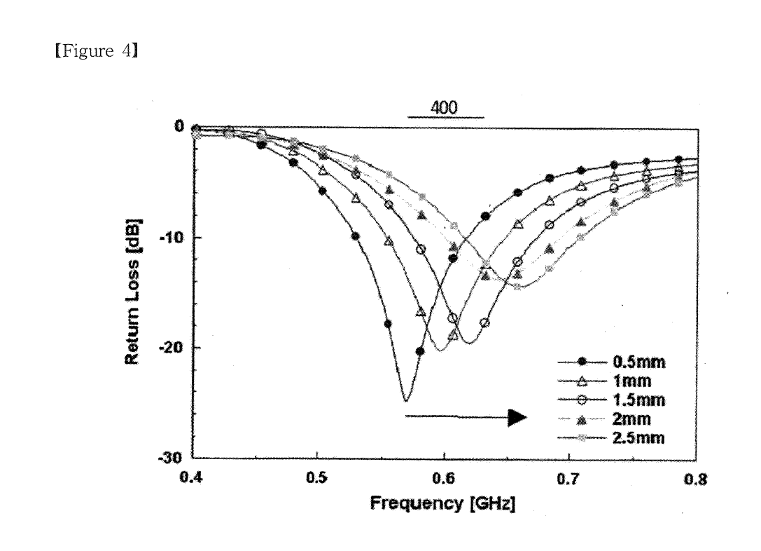

FIG. 4 shows an example of a change in return loss depending on a change in the distance between the rings. As shown in FIG. 4, a graph 400 illustrates return loss depending on the frequency when the distance 203 between the rings 101 is 0.5 mm, 1 mm, 1.5 mm, 2 mm and 2.5 mm.

From the graph 400, it can be seen that as the distance 203 increases from 0.5 mm to 2.5 mm, a resonant point shifts to a high frequency. This is because as the distance 203 between the rings 101 increases, the entire electrical length of the antenna is shortened.

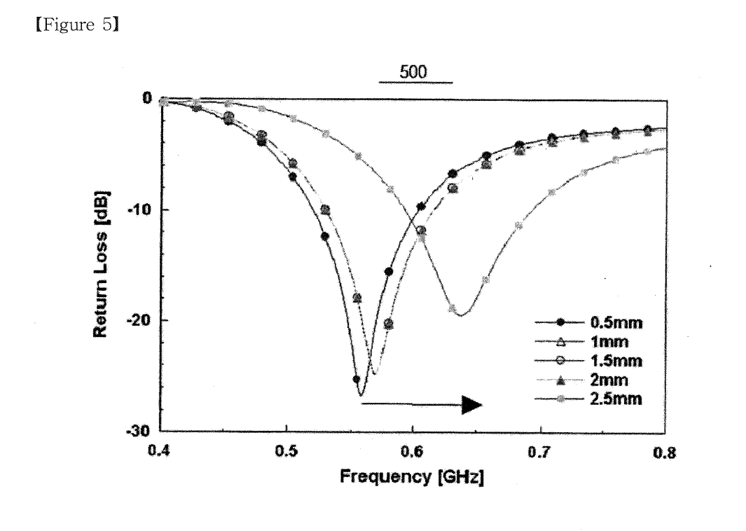

FIG. 5 shows an example of a change in return loss depending on a change in the diameter of a central conductor. As shown in FIG. 5, a graph 500 illustrates return loss depending on the frequency when the diameter 204 of the central conductor 102 is 0.5 mm, 1 mm, 1.5 mm, 2 mm and 2.5 mm.

From the graph 500, it can be seen that as the diameter 204 of the central conductor 102 increases from 0.5 mm to 2.5 mm, a resonant point shifts to a high frequency. This is because as the diameter 204 of the central conductor 102 increases, an effective diameter of the ring decreases and therefore the electrical length of the antenna is shortened.

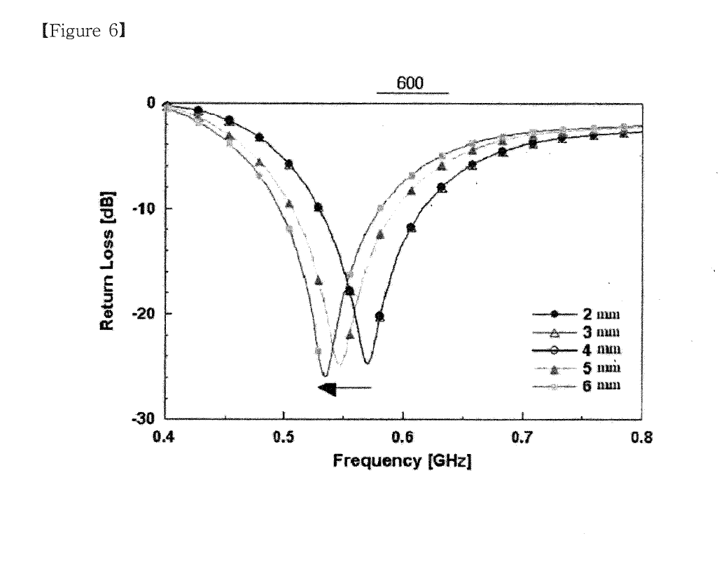

FIG. 6 shows an example of a change in return loss depending on a change in the diameter of the ring. As shown in FIG. 6, a graph 600 illustrates return loss depending on the frequency when the diameter 202 of the ring 101 is 2 mm, 3 mm, 4 mm, 5 mm and 6 mm.

From the graph 600, it can be seen that as the diameter 202 increases from 2 mm to 6 mm, a resonant point shifts to a low frequency. This is because the electrical length is lengthened as the diameter 202 of the ring 101 increases.

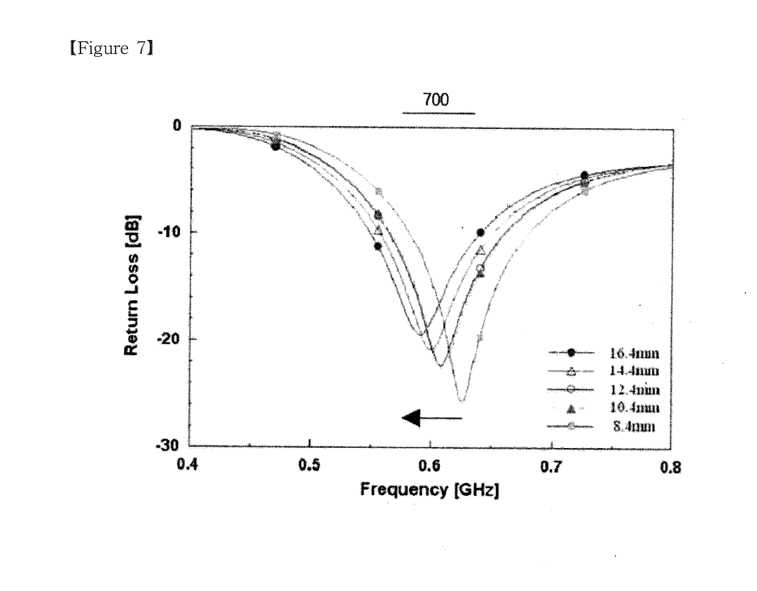

FIG. 7 shows an example of a change in return loss depending on a change in the entire length of the parallel ring. As shown in FIG. 7, a graph 700 illustrates return loss depending on the frequency when the length of the parallel ring 200 is 16.4 mm, 14.4 mm, 12.4 mm, 10.4 mm and 8.4 mm. From the graph 700, it can be seen that a resonant point shifts to a low frequency as the entire length of the parallel ring 200 increases from 8.4 mm to 16.4 mm.

If the entire length of the parallel ring 200 increases as described above, the electrical length of the antenna increases. Thus, there is an effect in that the entire physical length of the antenna can be reduced for the same resonant point.

As described above with reference to FIGS. 3 to 7, there are effects in that the resonant point shifts to a high frequency as the thickness 201 of the ring 101, the distance 203 between the rings 101 or the diameter 204 of the central conductor 102 increases, and the resonant point shifts to a low frequency as the diameter 202 of the ring 101 or the entire length of the parallel ring 200 increases. As described above, the integrated antenna 100 can obtain a desired bandwidth depending on how the parallel ring 200 is designed. In other words, the integrated antenna 100 in accordance with the present invention is advantageous in that it can easily secure a bandwidth, facilitates a change of the frequency, and can be tuned easily. Further, the gain of the antenna can be increased since the volume of the radiator is increased when compared with the chip antenna by employing the parallel ring 200.

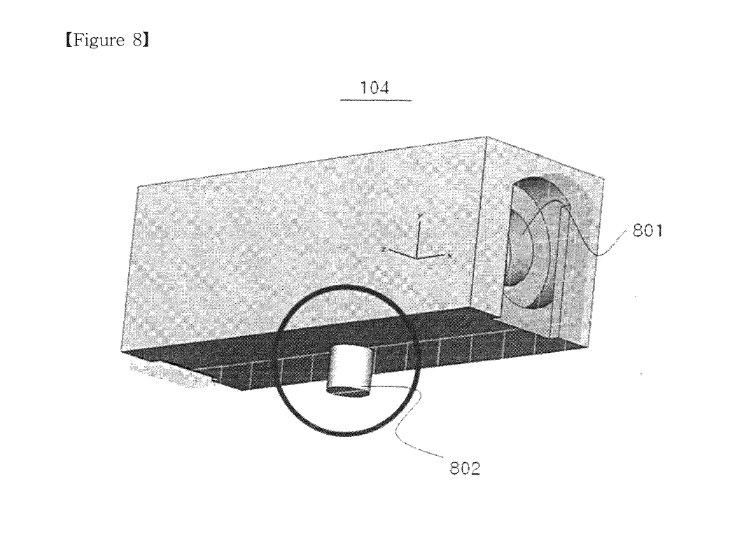

FIG. 8 is a view illustrating a high dielectric constant in accordance with an embodiment of the present invention.

A high dielectric body 104 has a groove 801 formed therein to correspond to the parallel ring 200. The parallel ring 200 can be coupled to the high dielectric body 104 through the groove 801. This high dielectric body 104 functions to prevent short of the integrated antenna 100 and miniaturize the integrated antenna 100 by employing the dielectric body. The high dielectric body 104 may further include a fixed pin 802 so as to be fixed to a PCB. The integrated antenna 100 can be fixed to the PCB through the fixed pin 802 without movement.

Meanwhile, the high dielectric body 104 may be formed of PPS (Polyphenylene Sulfide) with relative dielectric constant of 15 or more. The high dielectric body 104 can be fabricated in a desired form through injection molding. Preferably, the high dielectric body 104 and the parallel ring 200 can be integrally formed through insert molding.

As described above, the integrated antenna 100 in accordance with the present invention can have advantages in that it can have its size changed easily (that is, can be miniaturized) and have its structure changed easily by employing the high dielectric body 104.

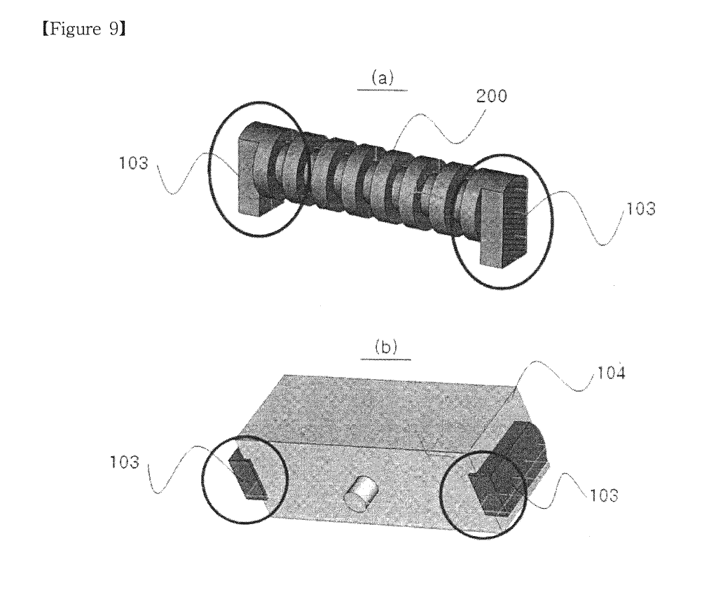

FIG. 9 is a view illustrating the contact structures in accordance with an embodiment of the present invention. In FIG. 9, reference numeral “a” designates two contact structures 103 included in the parallel ring 200, and reference numeral “b” designates a shape in which the high dielectric body 104 is coupled to the parallel ring 200 including the contact structures 103.

The contact structures 103 are mounted in the PCB. One of the contact structures 103 may serve as a feed line without directivity and the other thereof may serve as the ground and entirely form a loop antenna. However, only one of the contact structures 103 may be used as the feed line, but the other thereof may be opened, so they can be used as an inverse L-type antenna or a monopole antenna.

As described above, the integrated antenna 100 in accordance with the present invention can obtain a maximum gain and active performance while maintaining the size of an existing chip antenna and can have its size and structure changed easily and conveniently by combining the high dielectric body with the parallel ring. Further, the integrated antenna can obtain a bandwidth easily, have its frequency changed easily and can be tuned easily by employing a change in return loss depending on a change in the ring thickness of the parallel ring, the distance between the rings, the diameter of the ring or the diameter of the central conductor. In addition, the manufacturing cost can be saved through a structure that can be implemented without any carrier.

Furthermore, a radio transceiver including the integrated antenna 100 can include all the advantages of the integrated antenna 100 and is advantageous in that it can be designed simply since the structure of the integrated antenna 100 can be changed easily and conveniently.

Although the specific embodiments of the present invention have been disclosed for illustrative purposes, those skilled in the art will appreciate that various modifications, additions and substitutions are possible, without departing from the scope and spirit of the invention as disclosed in the accompanying claims.

Therefore, the scope of the present invention is not limited by or to the embodiments as described above, and should be construed to be defined only by the appended claims and their equivalents.

1. An integrated antenna comprising:
a parallel ring including a plurality of rings and a central conductor; and
a high dielectric body coupled to the parallel ring.

2. The integrated antenna of claim 1, wherein a return loss is changed depending on a thickness of the ring, a first diameter, i.e., a diameter of the ring, a distance between the rings or a second diameter, i.e., a diameter of a central conductor.

3. The integrated antenna of claim 1, wherein the parallel ring includes at least one contact structure mounted in a Printed circuit board (PCB).

4. The integrated antenna of claim 3, wherein the contact structure is two in number so as to coupled to a feed line and a ground GND, respectively.

5. The integrated antenna of claim 1, wherein:
the high dielectric body has a groove formed therein to correspond to an external shape of the parallel ring, and
the parallel ring is coupled to the high dielectric body through the groove.

6. The integrated antenna of claim 1, wherein the high dielectric body comprises a fixed pin so as to be fixed to a PCB.

7. A radio transceiver including the integrated antenna according to claim 1.
